(19) United States
(12) Patent Application Publication
(10) Pub. No.: US 2008/0008985 A1
(43) Pub. Date: Jan. 10, 2008

(54) eSubstitute : online substitute teacher scheduling system

(76) Inventor: Maretta Shaw, Worden, IL (US)

Correspondence Address: Maretta Shaw, 177 Brook Rd, Worden, IL, 62097, US

(21) Appl. No.: 11/426,590

(22) Filed: Jun. 27, 2006

(51) Int. Cl. G09B 3/00

(52) U.S. Cl. 434/350

(57) ABSTRACT

The invention is an online web based system for use by schools districts both private and public which enables online scheduling of substitute teachers and provides for professional development of the substitute teachers.

### FIELD OF THE INVENTION

The present invention is an online system which enables online substitute teacher scheduling and professional development of substitute teachers. It can be used by school districts both private and public.

### DESCRIPTION OF THE RELATED ART

It can be appreciated that there is no similar system in use.

### BACKGROUND OF THE INVENTION

Presently substitute teacher scheduling is done in two ways:

1) A school district hires someone to receive calls from teachers or their principles that a replacement is needed. The person collects the information of where and when the substitute is needed. Usually these calls take place the mornings of the actual day when the substitute is needed. The person then begins calling substitutes until someone takes the opening. This method could take up to 20 minutes or more to complete.
2) Some districts have an Interactive Voice Response system that the teachers call and leave a voice recording of the replacement details. Then the system calls substitutes until one accepts the opening. Some future positions are available via phone number to hear and accept.

However neither of these methods allows the substitute to review lesson plans beforehand, matching substitute to job they are qualified or comfortable nor do they give full details of the opening or provides for professional development of the substitutes.

To overcome these flaws in the existing system of substitute teacher scheduling, the inventors have come up with a new web based online system which enables online substitute teacher scheduling and professional development of substitute teachers.

### SUMMARY OF THE INVENTION

In view of the absence of any existing product, the present invention provides a new system for online substitute teacher scheduling and for professional development of the substitute.

The general purpose of the present invention, which will be described subsequently in greater detail, is to provide a new system for online substitute teacher scheduling and for professional development of the substitute and which can be used by school districts, both private and public. It has many advantages and many novel features developed by the inventors which is not anticipated, rendered obvious, suggested, or even implied by any existing product, either alone or in any combination thereof.
To attain this, the present invention comprises of:
1. An online, web based system having database of substitute teachers and their details and located at www.esubstitute.net
2. An Interactive voice response system
3. Professional development portal

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction. The invention is capable of other embodiments and of being practiced and carried out in various ways. Also, it is to be understood that the phraseology and terminology employed herein are for the purpose of the description and should not be regarded as limiting.

The primary object of the present invention is to enable online scheduling of substitute teachers and to further their professional development.

Other objects and advantages of the present invention will become obvious to the reader and it is intended that these objects and advantages are within the scope of the present invention.

### DETAILED DESCRIPTION OF THE INVENTION

Inventors have combined an online web based system, an interactive voice response system and a professional development portal.

The invention is for use by school districts, both public and private. The entire invention revolves around the website www.esubstittue.net. The website www.esubstitute.net is a subscription site. The school districts can buy subscriptions to the site. Once the school district buys the subscriptions, the teachers and substitutes in the school district can register on the site and begin using it. Upon registering on the site, the substitute teacher can enter his or her details into the database.

At the site www.esubstitute.net there is a manager for every school district who overseas the entire process of substitute scheduling.

Whenever a regular teacher requires a substitute, he or she logs on to www.esubstitute.net and enters the requirement for a substitute. The requirement can be posted up to thirty days in advance. The regular teacher has to enter the start time of the requirement. Based on the start time entered, the system automatically decides if the requirement is to be filled in less than 24 hours or not.

### Option 1: The requirement needs to be filled in less then 24 hours.

If the requirement needs to be filled in less than 24 hours, the interactive voice response system will begin calling qualified substitute teachers from the database who qualifications match the requirement and notifies them of the requirement. Emails are also sent to such substitute teachers notifying them of the requirement. Emails are then sent to the regular teacher and the district manager informing whether the requirement has been filled or not. If the requirement has been filled, the requirement is closed in the system.

### Option 2: The requirement need not be filled in less than 24 hours

If the requirement need not be filled within 24 hours, the requirement shall remain posted on the site. Qualified substitute teachers are then informed by email about the requirements and they can view the requirement and can accept or reject the requirement by email. If the requirement is accepted, then it is closed in the system. If it is rejected, then it is reentered into the system until accepted or withdrawn by the teacher. At all times, the status of the requirement is reported to the district manager.

Other than email, text messaging is also available as a method of communication to the substitute teachers.

When the regular teacher enters the requirement for a substitute, the lesson plan is also uploaded to the site. This enables the substitute to know if he or she can perform the requirement. It also enables the substitute to be prepare ahead of time so they are more confident in the classroom.

The site also provides a third party service which will enable the substitute teachers to create and develop their own lessons. This service may subsequently provided in house.

The professional development portal is hosted by a third party. The portal provided information and skills about the profession and can be used by school districts and substitutes. The portal may be subsequently hosted in house.

The inventors are also planning to add a feature to the system which will have a read only calendar from which the substitute can see future requirements at a glance but will have to use emails to accept or reject the requirements.

The invention is capable of further improvements and developments and the claim is extended to such further improvements and developments as may be.

1. An online web based system for online substitute teacher scheduling and for professional development of the substitute teacher.
